(19) United States
(12) Patent Application Publication
(10) Pub. No.: US 2002/0094070 A1
(43) Pub. Date: Jul. 18, 2002

(54) Telephone use-monitoring system and method

(76) Inventors: Charles J. Mott, Idaho Falls, ID (US); Jon S. Jacobsen, Idaho Falls, ID (US); David A. Remien, Idaho Falls, ID (US)

Correspondence Address: REED SMITH LLP, 375 PARK AVENUE, NEW YORK, NY, 10152, US

(21) Appl. No.: 09/725,377

(22) Filed: Nov. 29, 2000

(51) Int. Cl. H04M 15/00

(52) U.S. Cl. 379/133; 379/111; 379/112.01; 379/114.01; 379/134

(57) ABSTRACT

An information monitoring system, and a method of monitoring information, are disclosed. The information monitoring system includes a network, at least one central server, at least two site servers, and at least two telephone exchanges, wherein at least one telephone exchange is connected to each site server. The system also includes at least two site server compilers, wherein each site server compiler compiles a first plurality in a universal database format, and at least one central server compiler, wherein the at least one central server compiler compiles the universal database formats into a primary universal database. The method includes providing a network, connecting at least one central server to the network, connecting at least two site servers to the network, providing at least two telephone exchanges, connecting at least one of the telephone exchanges to each site server, providing at least two site server compilers, downloading a first plurality of data from the at least one telephone exchange to the site server compiler connected thereto, converting the first plurality of data to the universal database format, providing at least one central server compiler, and compiling, by the at least one central server compiler, of each universal database into a primary universal database.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention is directed generally to a method and apparatus for telephone monitoring and, more particularly, to a telephone use-monitoring system and method.

2. Description of the Background

FIG. 1 illustrates an exemplary historical telephone use monitoring system. A public branch exchange 10 (PBX) is a telephone exchange, i.e. a telephone switch, that allows direct inward dialing. A PBX 10 typically is identified by a public telephone number or family of telephone numbers, and the PBX 10 uses the public telephone number or numbers as routing information for routing of a call to the desired location of the caller. A station message detail report (SMDR) 12 is generally kept with respect to the PBX 10, detailing the call accounting records for that PBX 10. The SMDR 12 includes information on when a particular call was started, when the call ended, and where the call was from and/or to. This SMDR 12 may be generated during the call, or after a call is completed by a hang up, for example. Historically, the process of collecting telephone call data, such as the SMDR 12, from a PBX 10 in, for example, a corporate environment, has entailed the connection of a computer 14 to the PBX 10. This process of data collection has consisted of communication by the PBX 10 of the call accounting records 12 through an RS 232 serial cable 16, or similar hard-wired serial connection, to the attached computer 14.

Alternative methods of collecting call data have historically included the polling of the PBX 10 by at least one polling device 20, over, for example, an RS 232 serial cable 16. The polling device 20 polls the PBX 10 and collects the call accounting data 12, which call accounting data 12 may be buffered, such as by the PBX 10 itself, between polling events. This process may also include polling by a central call accounting system 22 over a modem 24 connected to the polling device 20, or the PBX 10, by the serial line 16, for example. Thus, in existing methods for call accounting data collection, either an intermediate polling device 20, or a single computer 14 on-site for information tracking and storage, such as an SMDR box 14, must be provided. In a commercial system, the cost may be significant per SMDR box per site, and even the unreliable polling device 20 may add significant cost per site. These high costs create greater risk in the danger that, because the entire network record-keeping may be dependent on a single box 14 or a single polling device 20, the failure of that box 14 or polling device 20 causes catastrophic failure of an already expensive system.

These existing call data collection methods do not expand or scale well. The use of an on-site computer 14 makes accumulation of wide-region calls for several offices cumbersome, and the use of one central call system 22 often presents a prohibitive cost. Further, the central system 22 typically has to make modem 24 calls to connect to the PBX polling device 20, or to directly poll the PBX 10, and modem connections are inherently unreliable, often having an effective connection rate of less than 90 percent. Further, a modem call for polling or connection to a central system 22 is normally a long distance call, and, to increase reliability of the inherently low-reliability modem connection, a low baud rate is maintained. Due to the large volume of records necessitated to record SMDR data 12, and the need to buffer to not exceed the low baud rate, the long distance calls needed to receive the records may take exceedingly long periods of time, and consequently may add greatly to the operating costs of such systems.

Trunk usage fees create additional concerns for telephone use-monitoring systems historically in use. After long distance fees, trunk fees paid for the local telephone exchange typically represent the largest monthly cost for a telephone system. The number of trunks used in and purchased for a telephone system should be sized for the maximum number of calls simultaneously expected at that telephone system site. Too few trunks are easily detected by the receipt by the caller of a busy signal, but too many trunks are difficult to detect using historical telephone monitoring systems, and it is not uncommon for a telephone system to have up to, or in excess of, 50% excess trunk capacity.

Thus, costs for connections to a local exchange carrier are typically priced according to trunk capacity. Direct connections, such as T-1 connections, to long distance carriers, which direct connections bypass the local exchange, are typically priced on metered usage, and the actual trunk capacity is relatively inexpensive in comparison to the local exchange. Therefore, it may be advantageous to reduce local exchange trunk capacity and obtain a direct connection to a long distance carrier, in order to reduce excess costs. In other cases where long distance calls are relatively few, it may prove more advantageous to route all long distance calls through the local exchange and not purchase a direct connection to a long distance carrier. This decision whether to purchase a direct connection to a long distance carrier, or to route all calls through the local exchange, can be made based on SMDR data. Similarly, optimum trunk capacity from the local exchange carrier can also be determined with the aid of SMDR data.

Call accounting systems 8 historically used do not exhibit an exact method of timekeeping, due to the fact that the time stamp on a call record used is dependent on the self-contained telephone system's ability to correctly keep time internally. Further, PBX switches often time stamp a call based on an internal PBX clock, which internal PBX clocks are typically only accurate within a few minutes of the actual time. In light of the fact that call carriers keep call records according to exact time stamps, which time stamps are synchronized with national standard time, it is critical for use monitoring that the time of any call accounting system 8 be synchronized with call carrier time. The synchronization of call accounting record time stamps with national standard time allows the correlation of call records, such as standard telephone bills or electronic telephone bills from a call carrier, to the actual PBX call accounting data 12. This correlation can provide a check to insure the call carrier's billing is error free.

Further, most public telephone branches are proprietary in their use, and thus most systems use a particular brand of PBX 10. The proprietary nature of most telephone branches makes the use and expansion of a use-monitoring system difficult. Frequently, proprietary systems use a dedicated private network to maintain system-wide call records, although some call carriers use the public internet to poll certain of the call carriers devices to obtain call records. However, the polling over the internet can only be performed by that call carrier on the proprietary system of that carrier, meaning that only systems owned or operated by that carrier using the single type of switch used by that carrier can be communicated with by the carrier central site over the internet. Nonetheless, only a very small percentage of PBXs in any system are connected to an IP network, and even those that are so connected present use-monitoring concerns due to their proprietary nature.

Therefore, the need exists for a telephone use monitoring system that allows communication with many or all types of PBX, does not require the polling of a PBX to gain call data, provides system wide time in accordance with call carrier time, and provides easy system expansion, redundancy in the case of breakdown, and improved monitoring of, for example, telephone trunks.

### BRIEF SUMMARY OF THE INVENTION

The present invention is directed to an information monitoring system. The information monitoring system includes a network having a plurality of interconnected nodes, at least one central server, at least two site servers, at least two telephone exchanges, wherein at least one telephone exchange is connected to each site server, at least two site server compilers, wherein each site server compiler downloads a first plurality of data from at least one telephone exchange connected thereto and stores that first plurality as a universal database format, and at least one central server compiler, wherein the at least one central server compiler compiles the universal database formats into a primary universal database. Multiple central servers may be situated in a hierarchical fashion, thus leading to the generation of multiple primary databases, each of which may then feed a second primary database, and that second primary databases may feed a third primary database, and so on. Due to the fact that a universal database format is generated based on the output of each telephone exchange, the present invention can be used with any type of proprietary public branch exchange telephone switches. Further, in a preferred embodiment, each server on the network is communication with a network timed protocol, thereby allowing for the maintenance of system wide time in accordance with call carrier time.

The present invention also includes a method of monitoring information. The method includes providing a network having a plurality of interconnected nodes, connecting at least one central server to the nodes, connecting at least two site servers to the nodes, providing at least two telephone exchanges, connecting at least one of the telephone exchanges to each site server, providing at least two site server compilers, communicating between each site server compiler and at least one telephone exchange, downloading a first plurality of data from the at least one telephone exchange to the site server compiler connected thereto, converting by that site server compiler of the first plurality of data to the universal database format, storing the universal database format in the site server compiler, providing at least one central server compiler, continuously communicating between the central server compiler and at least two site server compilers, downloading, by the at least one central server compiler, of the universal database format from each site server compiler, and compiling, by the at least one central server compiler, of each universal database into a primary universal database. The method may further include the arranging of the central server in a hierarchical fashion, leading to the generation of a second universal database based on the generation of a series of primary universal databases, and so on.

The present invention solves problems experienced with the prior art because it allows for telephone use monitoring by communicating with many or all types of PBX, it does not require the polling of a PBX to gain call data, it provides system wide time in accordance with call carrier time, and it provides easy system expansion, redundancy in the case of breakdown, and improved monitoring of, for example, telephone trunks. Those and other advantages and benefits of the present invention will become apparent from the detailed description of the invention hereinbelow.

### BRIEF DESCRIPTION OF THE SEVERAL VIEWS OF THE DRAWING

For the present invention to be clearly understood and readily practiced, the present invention will be described in conjunction with the following figures, wherein:

FIG. 1 is a block diagram illustrating an exemplary historical telephone use monitoring system;

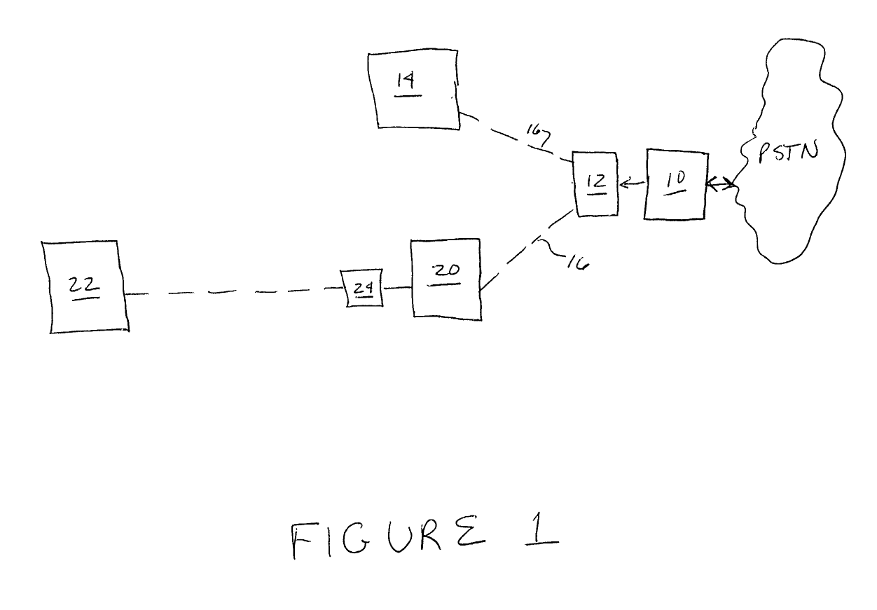

FIG. 2 is a schematic diagram illustrating an information monitoring system, such as a telephone use-monitoring system.

FIG. 3 illustrates an exemplary universal database for use in the present invention; and

FIG. 4 is a block diagram illustrating an embodiment of the present invention using a hierarchical system of central servers.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical telephone system and method. Those of ordinary skill in the art will recognize that other elements are desirable and/or required in order to implement the present invention. However, because such elements are well known in the art, and because they do not facilitate a better understanding of the present invention, a discussion of such elements is not provided herein.

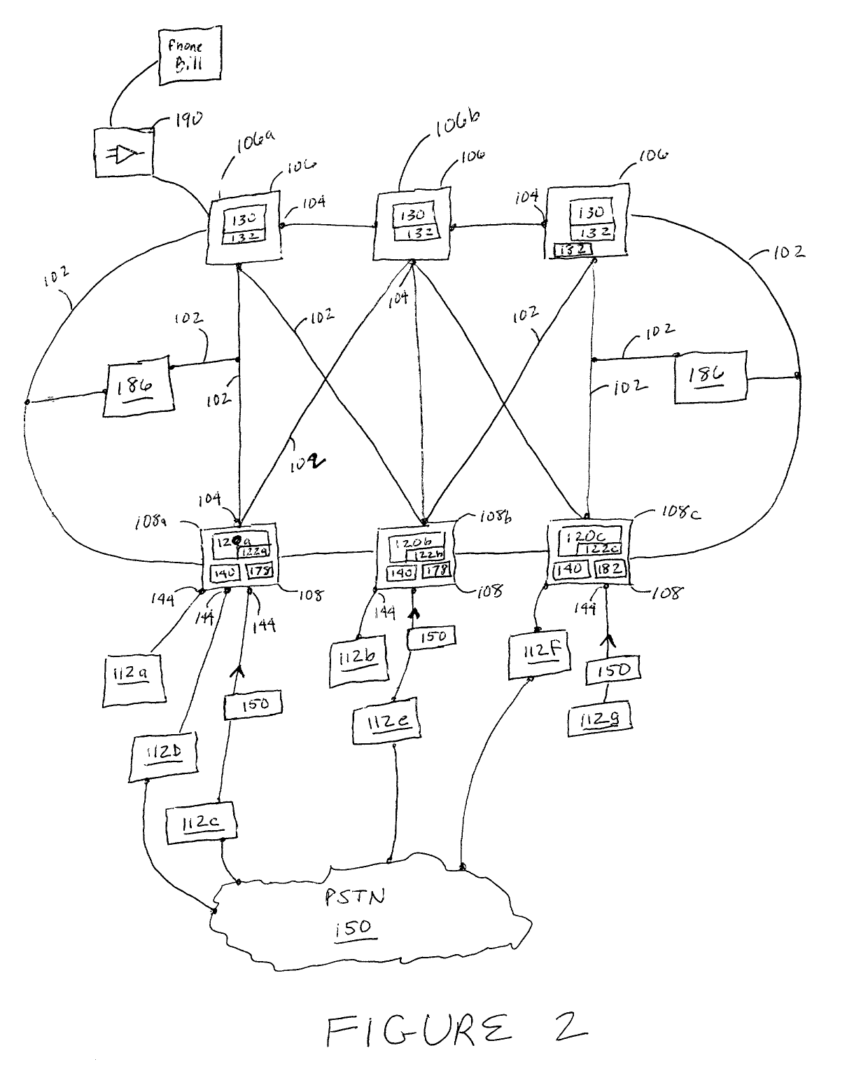

FIG. 2 is a schematic diagram illustrating an information monitoring system 100, such as a telephone use-monitoring system. The information monitoring system 100 includes a network 102 having a plurality of interconnected nodes, at least one central server 106 connected to one of the interconnected nodes 104, at least two site servers 108, wherein each site server 108a, 108b is connected to one of the interconnected nodes 104, at least two telephone exchanges 112a, 112b, wherein at least one telephone exchange 112a is connected to each site server 108a, at least two site server compilers 120a, 120b, wherein at least one site server compiler 120a is included at each site server 108a, and wherein a universal database 122a, 122b is stored in each site server compiler 120a, 120b, and at least one central server compiler 130, wherein at least one central server compiler 130 is included at each central server 106, and wherein the at least one central server compiler 130 compiles at least two of the universal databases 122a, 122b into a primary universal database 132.

The network having a plurality of interconnected nodes 104 may be a network 102 of the type known in the art, such as, but not limited to, a LAN, a WAN, the internet, or an intranet. The internet in this context is a publicly routable address which is not, for example, behind a fire wall in a protected environment. If the network 102 is the public internet, the preferred embodiment will include security measures for communication between the interconnected nodes 104. In a network 102 wherein the communications are passed through a public branch, such as the internet, it is preferable that secure shells, such as those that use secure cryptographics, are used to pass data between servers 106, 108a. These shells may be opened periodically, during which opening the site servers are queried for data by the central server or servers. Further, the network 102 is preferably a nearly-identical replicated system with built in redundancy at each node 104 on the network 102. The nodes 104 are represented by the availability of communication from a node point with the remainder of the network 102.

The at least one central server 106 is preferably at least one computer having data recordation and manipulation capability. Each central server 106 is connected to a corresponding one of the interconnected nodes 104 on the network 102, and, as such, preferably includes a web server thereon. The central server 106 may be a single server, or may be a master and slave server, or may be a main central server and a backup central server, at each central server node.

The at least two site servers 108a, 108b are preferably each at least one computer having data recordation and manipulation capability. Each of the site servers 108a, 108b is connected to a corresponding one of the interconnected nodes 104 on the network 102. In a preferred embodiment, each site server 108a is communicatively connected to at least one PBX 112a. This connection is preferably over a hard-wired serial cable, such as an RS232 serial cable, although other connection types will be evident to those skilled in the art. Each site server 108a, 108b is preferably individualized so as to allow communication with the particular proprietary PBX 112a or PBXs connected to that site server 108a. This individualization is preferably performed by assessing the communication format, such as the communication protocol, of an attached PBX 112a, and placing on the site server 108a, and then selecting at the site server 108a, that communication format for that particular PBX connection.

This individualization may be performed, for example, by a single software package 140, preferably installed on the hard drive or hard drives of each site server 108a, 108b or servers. In a preferred embodiment, within that software package 140 is a knowledge of a plurality of different PBX communication protocols, which are generally serial communication protocols for communication over an RS232. This knowledge may be generated using either an automated or manual communication format review. The user is asked to select, for each port 144 of the site server 108a connected to a PBX 112a, 112b, the communication form, i.e. the communication protocol, to be used for that port 144. This is similar to the selection of a connected printer type for an operating system on a PC. Thus, a single site server 108a can be connected to, and communicate with, numerous types of PBX switches 112a, 112c. These switches 112a, 112c may be made by, for example, Lucent®, Nortel®, or NEC®. The protocol by which these proprietary switches 112a, 112c communicate is known or readily ascertainable to those skilled in the art, and, therefore, the protocol necessary to allow communication between the PBX switch 112a, 112c and a particular computer, as present in the software package 140, will also be known or apparent to those skilled in the art. Alternatively, a universal software 140 that included and understood all possible PBX communication protocols is installed on the site server 108b, and such software 140 then readily communicates universally with all known PBX types. It will be apparent to those skilled in the art that this software package 140 allows communication from any proprietary PBX to be transformed into a universal output format, such as the universal database discussed hereinbelow, which universal output format is PBX vendor independent.

In a voice over IP embodiment of the present invention, such as PC to phone, or PC to PC telephony, the PC acting as the telephone generally communicates, at some point, with a PBX switch 112a, 112b for communication with the public switch telephone network (PSTN) 150, and, consequently, the present invention would operate substantially as set forth above, and the site server 108a, 108b would receive data from the PBX 112a, 112b using the correct serial PBX protocol. In alternative embodiments of the present invention, wherein the PC acting as a telephone is in direct communication with, for example, the internet 102, and not in communication with a PBX, the software package 140 of the present invention would preferably be in communication with the telephonic connection software, and would communicate the same SMDR information to the site server 108a (which could be the same computer acting as the telephone) as would be communicated by a PBX 112a, and thus the protocol for this voice over IP communication type would also preferably be included in the software package 140.

For example, in a typical office environment, PC-telephones may operate on an H.323 standard (i.e. programmed to use the internet), and the voice is packetized at the point of the PC-telephone. In this PC-telephony embodiment, a call director may, for example, connect a calling party to a PSTN trunk, and will then log the call and generate call accounting records at a central point. Consequently, most environments using PC-telephony include at least one element analogous to a PBX 112a, 112b, and call records can be generated using that analogous element. Further, these call records can then be stored in a universal database format using software embedded in that analogous element, or resident on a neighboring device, such as the site server 108a, 108b. In an alternative embodiment, the PC truly originates and sets up the call, in which case that PC would preferably include thereon the embedded software to originate the record, as discussed hereinabove.

The at least two telephone exchanges 112a, 112b include the telephone switch that makes a telephonic communication connection, such as, for example, either the PBXs or the internet, as discussed hereinabove. At least one telephone exchange 112a, 112c is connected to each site server 108a. The telephone exchanges send data streams to the connected site server, and such data streams may, for example, be in an ASCII data format. However, telephone exchanges 112a, 112b are generally available in numerous proprietary brands, each of which may follow a different communication protocol and format, as discussed hereinabove. The present invention re-formats each serial-communicating PBX 112a, 112b that communicates over a standard interface, such as RS232, to a universal PBX output, with PBX time synchronized to national standard time, for very low cost, and brings each PBX into an integrated universal system using, for example, off-the-shelf and open source software, as discussed herein.

The at least two site server compilers 120a, 120b are included at the site servers 108a, 108b. In a preferred embodiment, at least one site server compiler 120a is included at each site server 108a. Each site server compiler 120a communicates with at least one telephone exchange 112a, 112c, such as the PBX 112a, 112c connected to the site server 108a connected to that site server compiler 120a, and down loads a first plurality of data 150, which may be, for example, an SMDR, from the telephone exchange to the site server. The site server compiler 120a then converts that first plurality of data 150 to a universal database format 122a. The universal database format 122a is then stored in the site server compiler 120a.

The site server compiler 120a has a knowledge of the communication format and protocol of the telephone exchange 112a, and, using this knowledge, converts the first plurality 150 generated by the telephone exchange 112a and received at the site server into an entry in the universal database format 122a for storage. The site server compilers 120a, 120b, including the universal database formats 122a, 122b on each, are connected via the site servers 108a, 108b on which the site server compilers 120a, 120b are resident, to the network 102.

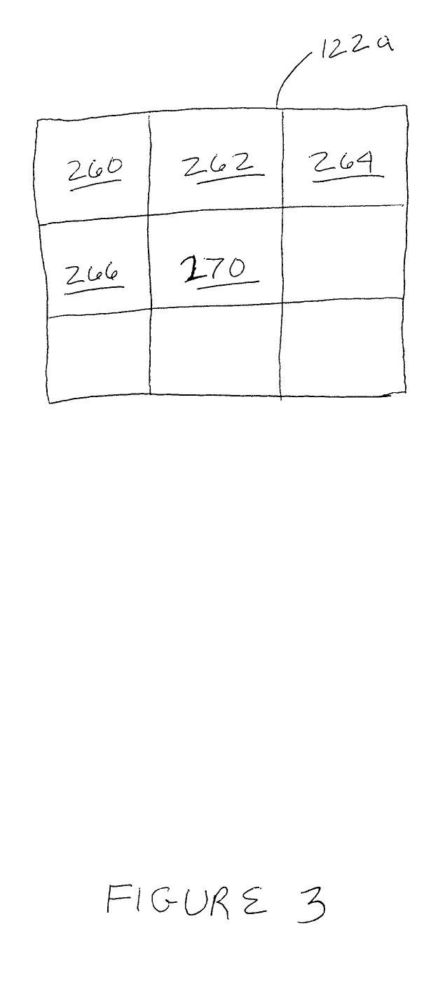

The first plurality 150, which is generally at least one call detail record, is thus, upon recordation at the site server compiler, a universal database format record 122a, 122b. The universal database format 122a, 122b may be any database, such as a relational database format, known to those skilled in the art. Additionally, the schema of the universal database may be any schema known to those skilled in the art. In a preferred embodiment, the schema of the universal database 122a, 122b includes three components: a call time stamp 260, a call collection geography 262 (PBX to and from identifiers, for example), and a globally unique identifier 264 that is distinct from any other identifier collected in the extended network. An exemplary universal database 122a is shown in FIG. 3.

The globally unique identifier 264 is preferably a unique code that identifies the geographic location, number, and type or proprietary brand of each telephone exchange 112a, 112b, such as a PBX, within the system 100. The PBX type is preferably empirically generated by the software package 140 by an assessment of the PBX raw data protocol and format, and the PBX type need not be given by the PBX itself. Additionally, in a preferred embodiment, the universal database schema includes a raw data component 266, which is a data string of the raw data passed from the PBX 112a, 112b to the site server 108a, 108b, in the PBX protocol format. Further, this raw data 266, or the universal database format record 122a, 122b, may additionally include a primary key sequence 270, i.e. a unique sequence of numbers and letters, that is used to uniquely refer to each universal database format entry. The software package 140 at the site server 108a, 108b converts the raw data 266 to the universal database format 122a, 122b, but may additionally retain a copy of the raw data 266 in the universal database format 122a, 122b. The universal database format 122a, 122b also preferably includes a call type. An exemplary format for the universal database format 122a, 122b is set forth in Table 1.

TABLE 1

| FIELD | TYPE |
|---|---|
| Smdr_id | Text (primary key) |
| Pbx_id | Text |
| Call_type | Int |
| Trunk_transfer | Int |
| Start_time | Datetime |
| Stop_time | Datetime |
| Station | Text |
| Called_number | Text |
| Ani | Text |
| Account_code | Text |
| Route | Text |
| Trunk | text |

The at least one central server compiler 130 is included at each central server 106. Each central server compiler 130 continuously communicates with at least two site server compilers 120a, 120b, and down loads the universal database format 122a, 122b from each of the two site server compilers 120a, 120b. Each central server compiler 130 then compiles each universal database 122a, 122b received into a primary universal database 132.

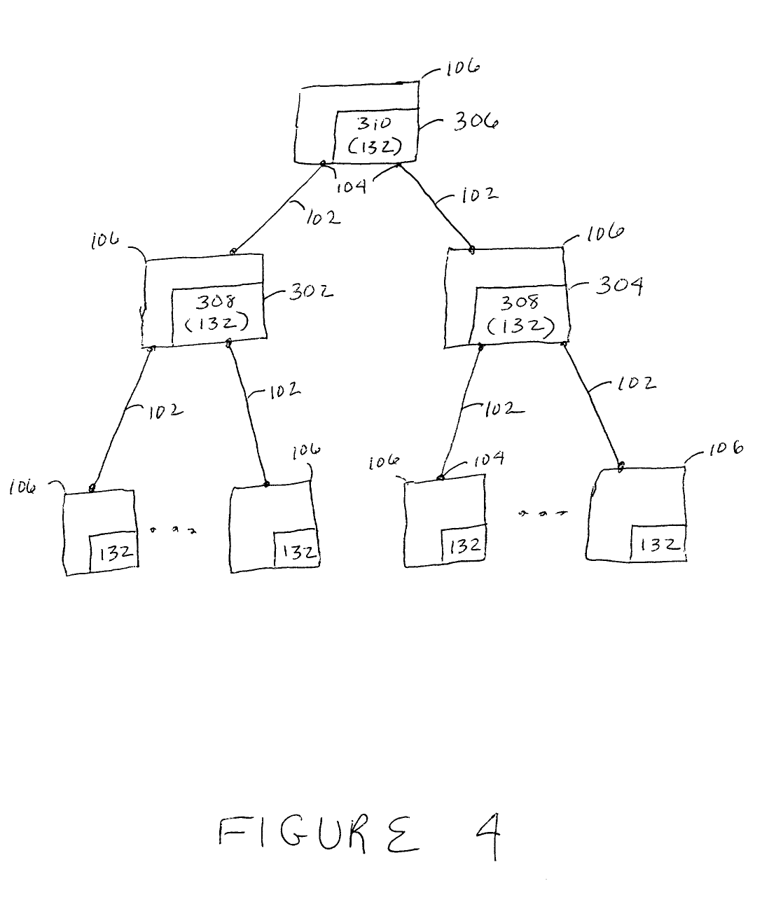

A hierarchical embodiment with respect to the central servers 106 is illustrated in FIG. 4. A single central server 106 may not be the ultimate destination for the primary universal database 132, but rather the central servers 106 may be arranged in a hierarchical fashion, in which numerous site servers feed a first central server 302, numerous other site servers feed a second central server 304, and the first and second central servers feed a third central server 306, for example. Thus, the primary universal database 132 may be downloaded via the network 102 from a first layer to a second layer of central servers 106, thereby forming a second primary database 308 (which is thus the equivalent of the primary universal database from the site servers), and so on. Additionally, numerous other central servers may be present, each having thereon a central server compiler, and one central server may record the primary universal database, while the other central servers record backup data, which backup central servers, in the event of a loss of data at the central server compiler including the primary universal database, can be used to maintain the primary universal database. Further, site server compilers preferably retain all data thereon from the attached telephone exchange, and thus the respective site server compilers can also be used as a backup to the central server compiler.

The central server compiler 130 has continuous contact with the site servers 108a, 108b via the interconnected network 102, and thus does not need to request a data dump over a predetermined time frame, nor does the central server 106 need to engage in any polling. Thus, call data records in the universal database format 122a, 122b are received at the central server 106 from the site servers 108a, 108b instantaneously. Polling may be used with the present invention, but is preferably a manner of buffering the arrival of data at the central server 106 or servers, rather than a manner of lowering contacting costs between the site servers 108a, 108b and the central server 106 or servers. Such polling may be performed by requesting data from all site servers 108a, 108b at once, and then accepting no data for a given period, or may be performed by individually polling site servers 108a, 108b, one at a time, in a round-robin fashion. In an embodiment wherein polling is performed, the data may be merged, for example, in a batch process, into the central server 106. The polling alert, i.e. the notification to the site server 108a, 108b that it is about to be polled, may come from either the central server 106, over the network 102, or from a timer 178 on the site server 108a, 108b itself.

Communication between the central server 106 or servers 106 and the site servers 108a, 108b may occur over the network 102 using a network protocol. For example, in an embodiment wherein the network 102 is the internet, an internet data protocol, such as UNIX SYS Log running on UDP, may be used for communication. Further, in order to simplify communication between site servers, and between site servers and central servers, a common operating system is preferably used on each server, such as Linux.

The data passed between the central server 106 or servers, and the site servers 108a, 108b, may, in additional preferred embodiments, be subject to a reconciliation by a reconciler 182 between the central server 106 or servers and the site servers 108a, 108b. This reconciliation is available in embodiments wherein the site server compiler 120a retains a copy of call record data at that site server, as does the central server 106 or servers. This reconciliation may, for example, be used to correct data error introduced in the sending of data between servers 106, 108a, 108b. This reconciliation is performed either automatically or manually, and, in either case, the manner of reconciliation will be apparent to those skilled in the art.

In order to allow for correlation with call carrier calling records, the time in the system 100 of the present invention is synchronized across all sites, and that synchronized time is synchronized to call carrier time, i.e. to national standard time. This synchronization may be performed by sending out information from the central server 106 to the site servers 108a, 108b, while the central server 106 tracks time, or each site 108a, 108b may keep its respective time using periodic updates, such as from the internet. For example, each site server 108a, 108b preferably has a very accurate view of time based on the network time protocol, due to the continuous connection of all site servers 108a, 108b to the network 102, because the network 102 either is, or is connected to, the internet. The internet has an extremely accurate notion of time, and, in fact, even servers that become disconnected from the network 102 preferably continue to keep time based on the last internet communication, thus introducing only an error of the slowness or fastness (i.e. the slew) of the site server's on-board clock, which error can be corrected or accounted for upon re-connection to the internet. Further, the network time protocol connection 186 can allow a site server 108a, 108b to recognize its own clock slew while connected, thus allowing the site server 108a, 108b to adjust itself while off-line. The network time protocol connection thus synchronizes each site server to national standard time.

In a preferred embodiment, the site server 108a places the time stamp on the call record 150 upon receipt from the telephone exchange 112a. This time stamp may be checked or corrected by the central server 106. This time stamp is typically accurate to within a 5 to 10 millisecond from national standard time. By contrast, a PBX's time stamp is generally accurate only to within five minutes. Due to the fact that the PBX 112a sends the call accounting records 150 to the site server 108a within a few seconds of when the actual call is completed, the time stamp assigned by the site server 108a is accurate to within the time window of the delay in sending from the PBX 112a to the site server 108a, i.e. to within a few seconds, rather than to within the five minute error of the PBX 112a.

The accuracy of the time stamp, and record keeping capabilities, of the present invention allow for a direct comparison, such as by a comparator 190, between a call carrier telephone bill, and the actual telephone usage. This comparison, which may be manual or automated, provides a record of the legitimacy of that call carrier bill, due to the fact that the time stamp used by the call carrier is the same time as that used by the system 100 of the present invention. In fact, even in cases where the call length is calculated by the call carrier to the second, and the call times to the minute, call records can be well correlated using the present invention. In the United States alone, some estimates place the current average error rate by the call carriers on call recordation at 35%. Thus, for larger companies, the system 100 of the present invention can generate telephone savings in the tens, or even hundreds, of thousands of dollars, and can generate substantial percentage savings for entities of all sizes.

The system 100 of the present invention provides built-in fault tolerance and geographic redundancy. The system is fault tolerant in that any one point in the system can fail, and data is lost, if at all, only at that one point. Geographic redundancy is generated by the placement of, for example, central servers 106 at more than one site. Thus, even if one central server 106 is lost, the other, or others, continue data collection, thus preventing data loss. The central servers 106 can then be reconciled to correct any data loss at the one or more offline central servers 106. Further, the site servers 108a, 108b can be controlled by any one of the central servers 106 to direct the call records in universal format 122a from that site server 108a to a secondary central server 106b until the primary central server 106a for that site server 108a is back on-line. Even in the case wherein there is only one central server 106, and that central server 106 crashes, or the case wherein all of the central servers 106 crash, the site servers 108a, 108b can still place correct time stamps, thus keeping the time stamps correct even if receipt at the central server 106 or servers is delayed, and the site server 108a, 108b or servers can buffer data at the site server 108a, 108b until the central server 106 or servers are back on-line, at which time the site server 108a, 108b or servers can retransmit.

The central servers, and the site servers, of the present invention preferably include thereon an internet server for sending information to internet browsers on PCs for displaying and manipulating information passed through the network of the present invention. The use of a web server eliminates the need for a special client at each server in an embodiment wherein the universal database formats, and the primary universal database, are formatted for display using a browser. Further, a browser connected to the web server allows for direct display of information received in a network environment. Other software capable of displaying and/or manipulating information may also be used with the present invention, such as a word processor or spreadsheet. In a preferred embodiment, all servers include the same or similar software for displaying and manipulating, thereby allowing ease of communication between servers.

The manipulation of the data, such as by using the internet browser on the web server, preferably allows the user at any server to make database inquiries and searches, for example, to organize data as desired by the user. For example, a user may wish to view all calls made from a particular extension, the total number of minutes spent on the phone at a particular extension in a given day, all calls made internationally on a particular trunk, or all calls billed to a particular client, using the present invention. Consequently, the present invention preferably maintains records, such as the universal database formats and the primary universal database, in standard report formats across all servers and clients, and structured query language (SQL) queries are preferably available using at least one client connected to at least one server in the present invention. Thus, reports for each site preferably include, for example, searchable cumulative data, such as local, long distance, international usage, use of account codes, and searchable individual call or location data, such as location, time of day, and length, trunk usage, and total usage. Such knowledge gained by the user from a search of the records of the system 100 of the present invention allows the user to setup the telephone system for optimal use of local exchanges, and optimal number of trunks, for example.

Those of ordinary skill in the art will recognize that many modifications and variations of the present invention may be implemented. The foregoing description and the following claims are intended to cover all such modifications and variations.

What is claimed is:

1. An information monitoring system comprising:
a network having a plurality of interconnected nodes;
at least one central server, wherein each of said at least one central servers is connected to a corresponding one of the interconnected nodes;
at least two site servers, wherein each of said at least two site servers is connected to a corresponding one of the interconnected nodes;
at least two telephone exchanges, wherein at least one telephone exchange is connected to each of said at least two site servers;
at least two site server compilers, wherein at least one site server compiler is included at each site server, wherein each of said site server compilers communicates with the at least one telephone exchange connected to said site server at which said site server compiler is included, wherein each of said site server compilers down loads a first plurality of data from the at least one telephone exchange connected to said site server, and wherein each of said site server compilers converts the first plurality of data to a universal database format, and wherein the universal database format is stored in said site server compiler;
at least one central server compiler, wherein at least one central server compiler is included at each central server, wherein at least one of said at least one central server compiler continuously communicates with at least two site server compilers and down loads the universal database format therefrom, and wherein said at least one central server compiler compiles each universal database into a primary universal database.

2. The information monitoring system of claim 1, wherein said network is at least one selected from the group consisting of a LAN, a WAN, an internet, and an intranet.

3. The information monitoring system of claim 2, wherein said network is the internet.

4. The information monitoring system of claim 1, further comprising at least one security measure for communication between the interconnected nodes.

5. The information monitoring system of claim 1, wherein said at least one central server is preferably at least one computer having data recordation and manipulation capability.

6. The information monitoring system of claim 5, wherein said at least one central server comprises a central server node having a network server connected thereto.

7. The information monitoring system of claim 5, wherein said at least one central server comprises a central server node having a master server and a slave server connected thereto.

8. The information monitoring system of claim 5, wherein said at least one central server comprises a central server node having a main central server and a backup central server connected thereto.

9. The information monitoring system of claim 1, wherein each site server is a computer having data recordation and manipulation capability.

10. The information monitoring system of claim 9, wherein each of said telephone exchanges is connected to said site server via a hard-wired serial connection.

11. The information monitoring system of claim 1, wherein each site server is individualized to allow communication with at least two proprietary telephone exchanges, wherein at least one proprietary telephone exchange is one of the at least two telephone exchanges connected the each site server.

12. The information monitoring system of claim 11, further comprising a software package installed on each site server, wherein said software package includes a knowledge of communication with at least two proprietary telephone exchanges, and wherein said software package is the individualizer.

13. The information monitoring system of claim 1, wherein at least one of the at least two telephone exchanges is a public branch exchange.

14. The information monitoring system of claim 1, wherein at least one of the at least two telephone exchanges is a voice over internet protocol exchange.

15. The information monitoring system of claim 1, wherein the first plurality is a SMDR.

16. The information monitoring system of claim 1, wherein the universal database format is a relational data base.

17. The information monitoring system of claim 16, wherein the relational database comprises a schema including a time stamp, a call geography, and a globally unique identifier.

18. The information monitoring system of claim 17, wherein the time stamp is placed by said site server receiving the first plurality.

19. The information monitoring system of claim 18, wherein the globally unique identifier comprises a unique code that identifies at least one of a geographic location, a number, and a proprietary brand of each of said telephone exchanges.

20. The information monitoring system of claim 19, wherein the schema further includes a raw data component.

21. The information monitoring system of claim 20, wherein the raw data component includes a primary key sequence.

22. The information monitoring system of claim 20, wherein the schema further includes a data type.

23. The information monitoring system of claim 1, wherein at least one of said at least one central servers receives the primary universal database from at least two other central servers, and wherein said central server compiler of said central server which receives the primary universal database from at least two other central servers compiles the at least two primary universal databases into a secondary universal database.

24. The information monitoring system of claim 1, wherein the at least two universal database formats are downloaded to said at least one central server instantaneously.

25. The information monitoring system of claim 1, wherein the at least two universal database formats are downloaded to said at least one central server via a polling by said at least one central server.

26. The information monitoring system of claim 1, wherein the communication between at least one of said at least one central server and at least two of said at least two site servers occurs over said network using a network protocol.

27. The information monitoring system of claim 26, wherein the network protocol is an internet data protocol.

28. The information monitoring system of claim 27, wherein the internet data protocol is UNIX SYS Log running on UDP.

29. The information monitoring system of claim 27, wherein the communication is performed using encrypted communication over the internet data protocol.

30. The information monitoring system of claim 1, wherein a common operating system is used on each of said at least two site servers and each of said at least one central servers.

31. The information monitoring system of claim 1, further comprising a reconciler that reconciles at least one of the universal database formats with the primary universal database.

32. The information monitoring system of claim 1, further comprising a plurality of time synchronizers, which time synchronizers are present at each of said at least two site servers and at each of said at least one central servers, wherein said time synchronizer receives a national standard time and updates time at each site server and each central server in accordance with the national standard time.

33. The information monitoring system of claim 32, wherein each time synchronizer includes a slew corrector that correct time slew on the corresponding time synchronizer due to a disconnect from the national standard time.

34. The information monitoring system of claim 33, further comprising a comparator that compares the primary universal database to a call carrier telephone bill, wherein said comparator assesses legitimacy of charges on the call carrier bill.

35. The information monitoring system of claim 1, further comprising a internet server resident on at least one of said at least one central server, wherein said internet server is communicatively connected to at least one of said central server compilers.

36. The information monitoring system of claim 1, further comprising an internet server resident on at least one of said at least one central server, wherein said internet server is communicatively connected to at least one of said central server compiler and at least one of said at least two site server compilers.

37. The information monitoring system of claim 1, further comprising an internet server resident on at least one of said at least two servers, wherein said internet server is communicatively connected to at least one of said at least two site server compilers.

38. The information monitoring system of claim 1, further comprising a internet server, wherein said internet server is communicatively connected to each of said at least two site server compiler and at least one of said at least one central server compiler.

39. The information monitoring system of claim 35 or claim 36 or claim 37 or claim 38, wherein said internet server includes thereon a network browser having database inquiry and searching capability.

40. The information monitoring system of claim 39, wherein the database inquiry and searching capability is an SQL query capability.

41. A method of monitoring information, comprising:
providing a network having a plurality of interconnected nodes;
connecting at least one central server, each to a corresponding one of the interconnected nodes;
connecting at least two site servers, each to a corresponding one of the interconnected nodes;
providing at least two telephone exchanges;
connecting at least one of the at least two telephone exchanges to each site server;
providing at least two site server compilers, wherein at least one site server compiler is provided at each site server;
communicating between each site server compiler and the at least one telephone exchange connected to the site server;
downloading a first plurality of data from the at least one telephone exchange to the site server compiler connected to the at least one telephone exchange using said communicating;
converting, by the site server compiler, of the first plurality of data to a universal database format;
storing the universal database format in the site server compiler;
providing at least one central server compiler, wherein at least one central server compiler is provided at each central server;
continuously communicating between at least one of the at least one central server compiler and at least two site server compilers;
downloading, by the at least one central server compiler, of the universal database format from each of the at least two site server compilers; and
compiling, by the at least one central server compiler, of each universal database into a primary universal database.

42. The method of claim 41, further comprising providing at least one security measure for communication between the interconnected nodes.

43. The method of claim 41, further comprising individualizing each site server to allow communication with at least two proprietary telephone exchanges, wherein at least one proprietary telephone exchange is one of the at least two telephone exchanges connected to each site server.

44. The method of claim 43, wherein said individualizing comprises empirically generating by a software package on the site server of an assessment of a communication protocol of the at least one proprietary telephone exchange.

45. The method of claim 43, wherein said individualizing comprises:
assessing the communication format of a connected telephone exchange;
placing on the site server the communication format of the connected telephone exchange;
selecting at the site server the communication format for the connected telephone exchange as the communication format for that site server.

46. The method of claim 45, wherein said placing and selecting comprise installing and manipulating, by a user, of a software package on each site server, wherein said software package includes a knowledge of communication with at least two proprietary telephone exchanges based on said assessing.

47. The method of claim 41, wherein the first plurality is a SMDR.

48. The method of claim 41, further comprising assigning a schema to the universal database, wherein the universal database schema includes at least a time stamp, a call geography, and a globally unique identifier.

49. The method of claim 48, further comprising stamping, by the site server, of the time stamp upon said downloading by the site server compiler of the first plurality.

50. The method of claim 41, further comprising receiving, by at least one of said at least one central servers, the primary universal database from at least two other central servers, and compiling by the central server compiler of the central server that receives the primary universal database from at least two other central servers of the at least two primary universal databases received into a secondary universal database.

51. The method of claim 41, wherein said downloading of the at least two universal database formats to the at least one central server is instantaneous.

52. The method of claim 41, wherein said downloading of the at least two universal database formats to the at least one central server comprises polling by the at least one central server.

53. The method of claim 41, further comprising using a common operating system on each of the at least two site servers and each of the at least one central servers.

54. The method of claim 41, further comprising reconciling at least one of the universal database formats with the primary universal database.

55. The method of claim 41, further comprising synchronizing time throughout the network.

56. The method of claim 55, wherein said time synchronizing comprises:
providing at each of said at least two site servers and at each of said at least one central servers, a time synchronizer that receives a national standard time; and
updating time at each site server and each central server in accordance with the national standard time.

57. The method of claim 56, further comprising correcting the slew on a time synchronizer due to a disconnect from the national standard time.

58. The method of claim 56, further comprising comparing the primary universal database to a call carrier telephone bill, and thereby assessing legitimacy of charges on the call carrier bill.

59. The method of claim 41, further comprising providing a internet server resident on at least one of said at least one central server, wherein said internet server is communicatively connected to at least one of said central server compiler.

60. The method of claim 41, further comprising providing a internet server resident on at least one of said at least one central server, wherein said internet server is communicatively connected to at least one of said central server compiler and at least one of said at least two site server compilers.

61. The method of claim 41, further comprising providing a internet server resident on at least one of said at least two servers, wherein said internet server is communicatively connected to at least one of said at least two site server compilers.

62. The method of claim 41, further comprising providing a internet server resident on at least one of said at least two servers, wherein said internet server is communicatively connected to at least one of said at least two site server compiler and at least one of said at least one central server compiler.

63. The method of claim 59 or claim 60 or claim 61 or claim 62, further comprising providing a database search capability for the universal database format and the primary universal database using a network browser on the internet server.

64. The method of claim 63, wherein the database inquiry and searching capability is an SQL query capability.

65. A telephone use monitoring system, comprising:
a network having a plurality of interconnected nodes;
at least one central server, wherein each central server is connected to a corresponding one of the interconnected nodes;
at least two site servers, wherein each site server is connected to a corresponding one of the interconnected nodes;
at least two telephone exchanges;
means for connecting at least one of the at least two telephone exchanges to each site server;
first means for compiling at each site server;
means for downloading a first plurality of data from the at least one telephone exchange to said first means for compiling, wherein said first means for compiling converts the first plurality of data to a universal database format;
means for storing the universal database format at said site server;
second means for compiling at each central server;
means for downloading the universal database format from each of the at least two site server to the central server, wherein said second means for compiling compiles each universal database into a primary universal database.

66. A telephone use monitor, comprising:
at least one central server, wherein each of said at least one central servers is connected to a corresponding one of a plurality of interconnected nodes in a network;
at least two site servers, wherein each of said at least two site servers is connected to a corresponding one of the interconnected nodes;
at least two telephone exchanges, wherein at least one telephone exchange is connected to each of said at least two site servers;
at least two site server compilers, wherein at least one site server compiler is included at each site server, wherein each of said site server compilers communicates with the at least one telephone exchange connected to said site server at which said site server compiler is included, wherein each of said site server compilers down loads a first plurality of data from the at least one telephone exchange connected to said site server, and wherein each of said site server compilers converts the first plurality of data to a universal database format, and wherein the universal database format is stored in said site server compiler;
at least one central server compiler, wherein at least one central server compiler is included at each central server, wherein at least one of said at least one central server compiler continuously communicates with at least two site server compilers and down loads the universal database format therefrom, and wherein said at least one central server compiler compiles each universal database into a primary universal database.

67. A communication device use monitor, comprising:
at least one central server;
at least two site servers communicatively connected to at least one of said at least one central servers over a network; and
at least two telephone exchanges;
wherein each of said site servers communicates with at least one telephone exchange connected to said site server, and wherein each of said site servers converts a first plurality of data from the connected telephone exchange into a universal database format, and wherein said at least one central server compiles each universal database into a primary universal database.
